(19) United States
(12) Patent Application Publication
(10) Pub. No.: US 2012/0298648 A1
(43) Pub. Date: Nov. 29, 2012

(54) CRIMPING METHOD AND CRIMPING SYSTEM

(75) Inventor: Satoru Gotou, Yokkaichi-city (JP)

(73) Assignee: DENSO CORPORATION, Kariya-city (JP)

(21) Appl. No.: 13/476,500

(22) Filed: May 21, 2012

(30) Foreign Application Priority Data
May 27, 2011 (JP) 2011-119173

(51) Int. Cl. H01T 21/02; B21J 1/06

(52) U.S. Cl. 219/154; 219/149

(57) ABSTRACT

A crimping method including the steps of: holding a workpiece comprised of a main body disposed around an outer circumference of a tubular shell in a first die; placing a second die for wrap crimping at a position facing the first die across the workpiece and moving the second die towards the first die to press the rim of the shell and plastically deform the rim to form a wrap crimped part; and bringing hot crimping-use electrodes arranged at sides of the shell, in a state holding the workpiece between the first die and the second die, into contact with side surfaces of the shell to apply current between the electrodes and the first die and make a thin-walled part to generate heat by resistance heating to thereby form a hot crimped part.

### BACKGROUND OF THE INVENTION

1. Field of the Invention

The present invention relates to a crimping method and crimping system used for a process of production of a product which has a wrap crimped part and a hot crimped part, for example, a spark plug.

2. Description of the Related Art

The basic structure of a spark plug for igniting fuel in an internal combustion engine is, for example, described in Japanese Patent Publication (A) No. 5-198350. In general, it is provided with an insulator through which a center electrode is inserted and held and a shell which is crimped and fastened to its outer circumference. The shell is a tubular member which is made of a metal. It grips the insulator between the crimped part at the top end and a step part at the shell inner circumference and is attached to the internal combustion engine by threads at the outer circumference of the bottom end.

As the related art relating to the method of production of a spark plug, in particular the crimping method, there are Japanese Patent Publication (A) No. 2002-164147 and Japanese Patent Publication (A) No. 2010-212230. Japanese Patent Publication (A) No. 2002-164147 is an invention which provides a crimped part at one open end of a shell and improves the dimensional precision and seal by making the crimped curved part a specific shape. As an example, it is disclosed to place talc or another filler layer and a seal ring in the opening of a crimping part and push down a crimping punch to crimp the open end part and make a thin-walled constricted part deform to form a thin-walled projecting shape. As the crimping method, cold crimping or hot crimping is employed. By forming the thin-walled projecting part by buckling the thin-walled part or heating it by resistance heating or by adjusting the speed of descent of the crimping punch, the positional relationships, and other settings, it is described that deformation of the locations other than the crimped part is prevented.

Japanese Patent Publication (A) No. 2010-212230 discloses a method of production of a spark plug comprising a step of inserting an insulator into an insertion hole of a main shell, a step of forming a pre-crimping part at a top end of the main shell to prepare a crimped part, and a step of pressing this in the axial direction to make a pre-compression deformation part deform. The crimped part at the top end is formed by setting the main shell and insulator between a first top die and bottom die placed at a press and moving the top die downward to perform wrap crimping. The compression deformed part is formed by hot crimping or cold crimping. In the case of hot crimping, the press is set with a second top die and bottom die having a higher conductivity than the first top die and bottom die and current is run between them to cause them to generate heat to cause deformation.

### SUMMARY OF THE INVENTION

In the production of a spark plug, for example, in a constitution not using talc or another filler, to secure the seal, the method is studied of wrap crimping the top end of the shell, then hot crimping it. However, when employing this method, in the past, the use of crimping for assembly was divided into the two steps of the wrap crimping step and hot crimping step. Dedicated crimping systems were provided for the respective steps. This will be explained next.

As shown in FIG. 9A, a conventional crimping system was structured with a pair of a top die 101 and bottom die 102 arranged facing each other straddling a spark plug P at its top and bottom positions. In the wrap crimping step, as shown in FIG. 9B, a system having a pair of a top die 103 and bottom die 104 for wrap crimping use is used. A spark plug P is held between the wrap crimping-use top die 103 (first top die) and bottom die 104. Further, the top die is moved downward to press the thin-walled tubular part P2 at the top end of the shell P1 by a round-shape shaping face 105 at the bottom end face to thereby form a wrap crimped part P3. Furthermore, at the hot crimping step, as shown in FIG. 9C, a system having a pair of a top die 106 (second top die) and bottom die 107 for hot crimping use is used to hold the spark plug P between the hot crimping-use top die 106 and bottom die 107. Further, while pressing, a power supply 108 is used to run current between the top die 106 and bottom die 107 to form the hot crimped part P4.

This is because, the die material is preferably made a hard material which is able to withstand the high load at the wrap crimping step. On the other hand, the die material is made a conductive material since it is used as an electrode for carrying current at the hot crimping step. Therefore, in the past, two crimping systems which were respectively provided with a pair of a top die and a bottom die such as in FIG. 9B and FIG. 9C had to be provided or a single crimping system had to be set with a top die and a bottom die for wrap crimping use, perform the wrap crimping, then be switched to dies for hot crimping use.

In this way, in the past, a system for wrap crimping use could not be used as a system for hot crimping use as it was. Further, when using two crimping systems corresponding to these steps, the capital costs became greater and the trouble was required of detaching and attaching workpieces for movement to the next step. Even when utilizing a single crimping system, resetting the dies was necessary for using dies dedicated to each step. A setup time resulted and productivity deteriorated.

Therefore, an object of the present invention is to provide a crimping method and crimping system which can be applied to a spark plug or other product of a structure which crimps a metal tubular shell to fasten it to the outer circumference of a main body, which enable wrap crimping and hot crimping to be performed by the same system without the exchange of the dies, which greatly shortens the time which is required for processing, and which reduces the capital costs and improves productivity.

To solve this problem, a crimping method according to a first aspect of the present invention comprises steps of: holding at a first die a workpiece comprised of a main body around an outer circumference of which a tubular shell is placed, moving a second die for wrap crimping use arranged facing the first die across the workpiece towards the first die so as to press the rim of one end of the shell, plastically deform the rim to an inner circumference side to thereby form a wrap crimped part and bringing hot crimping-use electrodes into contact with side surfaces of the shell to apply current between the electrodes and the first die and make a thin-walled part provided at current path of the shell generate heat by resistance heating to thereby form a hot crimped part.

A crimping method according to a second aspect of the present invention comprises a step of holding at a first die a workpiece comprised of a main body around an outer circumference of which a tubular shell is placed, a step of placing a second die for wrap crimping use facing the first die across the workpiece and moving the second die for wrap crimping use towards the first die so as to press the rim of one end of the shell and plastically deform the rim to an inner circumference side to thereby form a wrap crimped part, and a step of bringing hot crimping-use electrodes into contact with side surfaces of the shell, in the state holding the workpiece between the first die and the second die for wrap crimping use, to apply current between the electrodes and the first die and make a thin-walled part provided at current path of the shell generate heat by resistance heating to thereby form a hot crimped part.

A crimping method according to a third aspect of the present invention comprises a step of holding at a first die a workpiece comprised of a main body around an outer circumference of which a tubular shell is placed, a step of placing a second die for wrap crimping use at a position facing the first die across the workpiece and placing hot crimping-use electrodes at sides of the shell, a step of bringing the hot crimping-use electrodes placed at the sides of the shell into contact with side surfaces of the shell, a step of moving the second die for wrap crimping use towards the first die so as to press the rim of one end of the shell and plastically deform the rim to an inner circumference side to thereby form a wrap crimped part, and a step, in the state holding the workpiece between the first die and the second die for wrap crimping use, of applying current with the first die and make a thin-walled part provided at current path of the shell generate heat by resistance heating to thereby form a hot crimped part.

A crimping method according to a fourth aspect of the present invention comprising a step of holding at a first die a workpiece comprised of a main body around an outer circumference of which a tubular shell is placed, a step of placing a second die for wrap crimping use at a position facing the first die across the workpiece and placing hot crimping-use electrodes at sides of the shell, a step of bringing the hot crimping-use electrodes into contact with side surfaces of the shell, moving the second die for wrap crimping use towards the first die so as to abut against the rim of one end of the shell, and using the second die for wrap crimping use to press against the rim of the one end of the shell and plastically deform the rim to an inner circumference side to thereby form a wrap crimped part, and a step, in the state holding the workpiece between the first die and the second die for wrap crimping use, of applying current between the hot crimping-use electrodes and the first die to make a thin-walled part provided at current path of the shell generate heat by resistance heating to thereby form a hot crimped part.

A crimping method according to a fifth aspect of the present invention comprising a step of holding at a first die a workpiece comprised of a main body around an outer circumference of which a tubular shell is placed, a step of placing a second die for wrap crimping use at a position facing the first die across the workpiece and placing hot crimping-use electrodes at sides of the shell, a step of bringing the hot crimping-use electrodes into contact with side surfaces of the shell and applying preheating-use current Ia between the hot crimping-use electrodes and the first die to preheat a thin-walled part provided in current path of the shell, a step of moving the second die for wrap crimping use towards the first die so as to press the rim of one end of the shell and plastically deform the rim to an inner circumference side to thereby form a wrap crimped part, and a step, in the state holding the workpiece between the first die and the second die for wrap crimping use, of applying current between the hot crimping-use electrodes and the first die to make a thin-walled part provided at current path of the shell generate heat by resistance heating to thereby form a hot crimped part.

In a crimping method according to a sixth aspect of the present invention, preferably the wrap crimped part is formed by using the second die for wrap crimping use to press the workpiece by a pressing force Pa for wrap crimping use, while the hot crimped part is formed by running current through the hot crimping-use electrodes in the state using the second die for wrap crimping use to press the workpiece by a pressing force Pb for hot crimping use.

A crimping system in a seventh aspect of the present invention comprises a first die for holding a workpiece comprised of a main body around an outer circumference of which a tubular shell is placed, a second die for wrap crimping use which is arranged facing the first die across the workpiece, hot crimping-use electrodes arranged at sides of the shell, pressing means for moving the second die for wrap crimping use towards the first die and pressing one end of the shell by a predetermined pressing force, and current supplying means for bringing the hot crimping-use electrodes into contact with side surfaces of the shell and applying predetermined current between the electrodes and the first die.

The crimping system in the present invention may provide a plurality of the hot crimping-use electrodes substantially equally arranged at the outer circumference of the shell.

According to the crimping method of the first aspect of the present invention, it is possible to make a first die which holds a workpiece and a second die for wrap crimping use face each other to perform wrap crimping and to utilize the shell of the workpiece to provide hot crimping-use electrodes at its sides and run current with the first die to perform hot crimping. Therefore, it is possible to form the second die for wrap crimping use by a wear resistant material and form the hot crimping-use electrodes by a conductive material, there is no need to provide both a system for wrap crimping and a system for hot crimping, and the dies do not have to be switched, so it is possible to greatly shorten the processing time, reduce capital costs, and improve productivity.

According to the crimping method of the second aspect of the present invention, it is possible to wrap crimp a workpiece which is held at a first die using a second die for wrap crimping use, form a wrap crimped part at rim of one end of a shell, then use hot crimping-use electrodes to perform hot crimping as a series of steps in a single system. Further, it is possible to impart a pressing force to the workpiece in the hot crimping after wrap crimping through the second die for wrap crimping use, so it is possible to effectively perform hot crimping and improve the crimping force.

In the crimping method of the third aspect of the present invention, before using the second die for wrap crimping, it is possible to make the hot crimping-use electrodes abut against the workpiece which is held at the first die. Due to this, it is possible to use the second die for wrap crimping use to perform wrap crimping, then quickly use the hot crimping-use electrodes to perform hot crimping and possible to perform this step as a series of steps by a single system. By doing this, it is possible to effectively perform wrap crimping and hot crimping to improve the crimping force and shorten the processing time.

In the crimping method of the fourth aspect of the present invention, in the step of using the second die to perform the wrap crimping, it is possible to make the hot crimping-use electrodes abut against the workpiece which is held at the first die. In this way, in the method of crimping of the present invention using a first die which holds the workpiece, a second die for wrap crimping use, and hot crimping-use electrodes, the wrap crimping and the hot crimping can be simultaneously performed and the procedures are not restricted, so it is possible to more efficiently perform the series of crimping steps.

In the crimping method of the fifth aspect of the present invention, before using the second die for wrap crimping, it is possible to make the hot crimping-use electrodes abut against the workpiece which is held at the first die to perform preheating. By preheating the workpiece in this way, it is possible to efficiently perform the hot crimping after wrap crimping and possible to further improve the productivity.

According to the crimping method of the sixth aspect of the present invention, the pressing force by the second die for wrap crimping use is made variable, the wrap crimped part is formed by the pressing force Pa, then the pressing force Pa is changed to Pb to form the hot crimped part, so it is possible to effectively utilize common members to perform the wrap crimping and hot crimping.

According to the system of the seventh aspect of the present invention, it is possible to utilize the shell of the workpiece to arrange horizontal electrodes for hot crimping use at the sides and to form a single crimping system using a common bottom die and first die for wrap crimping use. Further, it is possible to form the hot crimping-use electrodes by a conductive material and form the second die for wrap crimping use by a wear resistant material so as to raise the durability of the system and to utilize a second die for wrap crimping use to give a pressing force for hot crimping use, so it is possible to efficiently perform wrap crimping and hot crimping so as to greatly shorten the processing time.

In the present invention, it is possible to provide a plurality of hot crimping-use electrodes and to use this plurality of electrodes to clamp and hold the shell and effectively perform the hot crimping.

### BRIEF DESCRIPTION OF THE DRAWINGS

The present invention may be more fully understood from the description of preferred embodiments of the invention, as set forth below, together with the accompanying drawings, wherein:

FIG. 1A is a schematic view of the configuration of a crimping system in a first embodiment of the present invention which shows a state at an original position before crimping;

FIG. 1B is a schematic view of the configuration of the crimping system which shows a state after crimping;

FIG. 1C is an enlarged view of principle parts of the crimping system for explaining a crimping method of the present invention;

FIG. 2A is a partial cross-sectional view which shows an overall structure and assembly structure of a spark plug as a workpiece to which the present invention is applied;

FIG. 2B is a partial cross-sectional view which shows an overall structure and assembly structure of a spark plug as a workpiece to which the present invention is applied;

FIG. 3 is a flowchart for explaining the crimping method of the present invention;

FIG. 4A is a view corresponding to the flowchart for explaining the crimping method in the first embodiment of the present invention;

FIG. 4B is a view corresponding to the flowchart for explaining the crimping method in the first embodiment of the present invention;

FIG. 5 is a view corresponding to the flowchart for explaining the crimping method in the first embodiment of the present invention;

FIG. 6A is a view corresponding to the flowchart for explaining a crimping method in a second embodiment of the present invention;

FIG. 6B is a view corresponding to the flowchart for explaining a crimping method in a third embodiment of the present invention;

FIG. 7A to FIG. 7E are schematic views for explaining shapes of hot crimping-use electrodes which are use for the crimping system of the present invention;

FIG. 8A to FIG. 8H are schematic views for explaining examples of the shapes and layouts of hot crimping-use electrodes which are use for the crimping system of the present invention;

FIG. 9A is a schematic view of the configuration of a conventional crimping system;

FIG. 9B is a view for explaining a wrap crimping method according to a conventional crimping system;

FIG. 9C is a view for explaining a hot crimping method according to a conventional crimping system; and

FIG. 10 is a flowchart for explaining the conventional crimping method.

### DESCRIPTION OF THE PREFERRED EMBODIMENTS

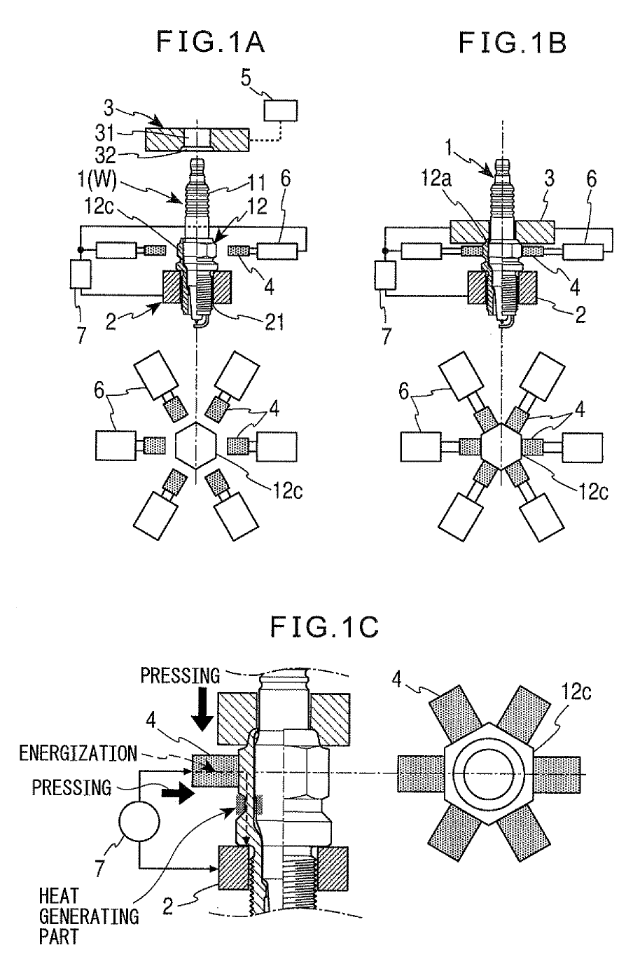

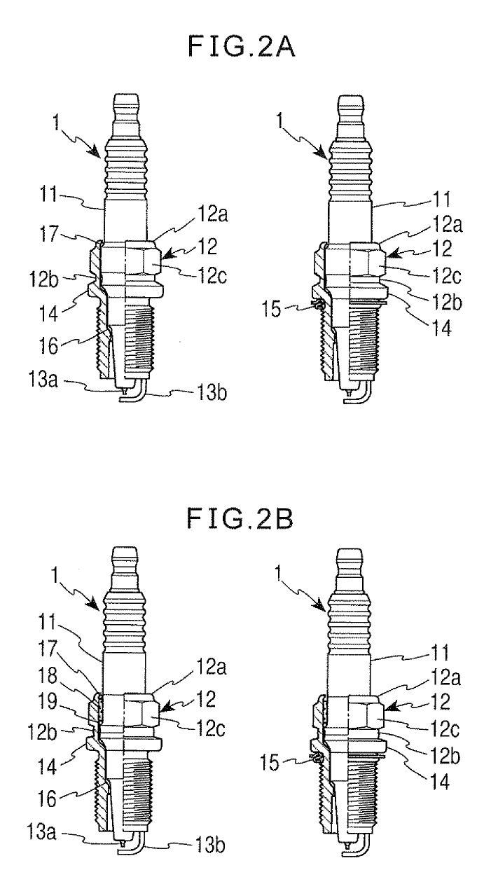

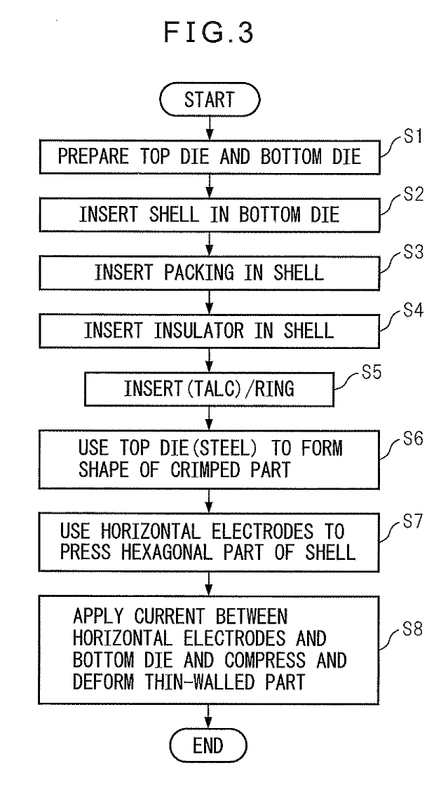

Below, referring to FIG. 1 to FIG. 5, a first embodiment of the present invention will be explained in detail. FIG. 1 is a view for explaining the general configuration of the crimping system and the crimping method which are used in the present embodiment, while FIG. 2 is a view of the overall configuration of a spark plug 1 as a workpiece W to which the crimping method of the present invention is applied. Further, FIG. 3 to FIG. 5 specifically show the procedure of the crimping method using the crimping system of FIG. 1. In FIG. 2A, the spark plug 1 which is used in a vehicle engine etc. is provided with a main body of an insulator 11 and a shell 12. The shell 12 is crimped and fastened to the outer circumference of the insulator 11 by the wrap crimped part 12a and the hot crimped part 12b which are provided at one end side (top end side in the figure). The insulator 11 holds a center electrode 13a inside it. A grounding electrode 13b which is fastened to the other end side of the shell 12 (bottom end side in the figure) by welding and the center electrode 13a face each other in the axial direction.

The shell 12 is a metal tubular member which has a thick part at one end side comprised of a hexagonal part 12c for attachment use. It uses a thin-walled part provided at the open end at the top of the hexagonal part 12c as the wrap crimped part 12a and the thin-walled part provided at the bottom of the hexagonal part 12c as the hot crimped part 12b. The other end side of the shell 12 is screwed into a mounting hole at a not shown engine cylinder head. A flange part 14 which is provided below the hot crimped part 12b and a gasket 15 are used to seal the mounting hole air-tightly (see right figure in FIG. 2A). The inner circumferential surface of the shell 12 is formed in a stepped shape along the outer circumferential shape of the insulator 11. A ring-shaped packing 16 is interposed in the clearance between the step part of the inner circumferential surface of the other end side and the step part of the outer circumferential surface of the insulator 11. Further, air-tightness is maintained by arranging a ring 17 for seal use inside of the wrap crimped part 12a at one end side.

As shown in FIG. 25, a tubular clearance may be formed between the hexagonal part 12c of the shell 12 and the insulator 11 and sealing use talc 18 may be filled in it. In this case, usually, talc powder is filled into the clearance and a sealing use ring 17 and ring 19 are placed above and below it. The seal structure of the spark plug 1 which is shown in FIG. 2A and FIG. 2B is suitably selected in accordance with the application of the spark plug 1, the size of the mounting part, etc. Other known structures may also be employed.

In FIG. 1A, the crimping system of the present invention has a first die for holding the workpiece constituted by a bottom die 2, a second die for wrap crimping use constituted by a wrap crimping top die 3, and hot crimping-use electrodes constituted by horizontal electrodes 4. The bottom die 2 has a holding hole 21 which is smaller in diameter than the flange part 14 of the spark plug 1 and inserts and holds the bottom half of the spark plug 1 inside the holding hole 21. The wrap crimping top die 3 is provided to be able to move up and down and, at the original position before crimping, is positioned above the spark plug 1 which is exposed from the holding hole 21. At the center part of the wrap crimping top die 3, a through hole 31 of a shape corresponding to the outer shape of the top half of the spark plug 1 is formed. The bottom end opening part 32 of the through hole 31 forms a round shape surface for forming the wrap crimped part 12a. The inside diameter of the through hole 31 is slightly larger than the maximum diameter of the insulator 11 which sticks out upward from the shell 12. As shown in FIG. 1B, when the wrap crimping top die 3 is moved downward, interference is prevented with the insulator 11.

The wrap crimping top die 3 functions as one of a pair of wrap crimping dies together with the bottom die 2 which is arranged facing it in the axial direction of the spark plug 1. For this reason, the wrap crimping top die 3 is configured by a wear-resistant material, for example a steel material etc. Further, a pressing mechanism 5 is provided as a pressing means for driving the wrap crimping top die 3 in the axial direction (up-down direction in figure) and pressing the top end of the shell 12 by a predetermined pressing force. The pressing mechanism 5 gives a pressing force which is required for forming the wrap crimped part 12a into a predetermined shape in the wrap crimping step and clamps the shell 12 to give a pressing force which is required for heat deformation of the hot crimped part 12b in the hot crimping step.

The horizontal electrodes 4 for hot crimping use are arranged at the sides of the hexagonal part 12c of the spark plug 1 and, together with the bottom die 2, function as parts of pairs of current carrying electrodes for hot crimping use. In the present embodiment, six horizontal electrodes 4 are arranged facing the six side surfaces of the hexagonal part 12c in a radial manner so as to surround the outer circumference of the hexagonal part 12c. The six horizontal electrodes 4 are connected with electrode drive units 6 which are arranged at the outer circumference sides and are provided so as to be able to be advanced and retracted in the radial direction of the spark plug 1.

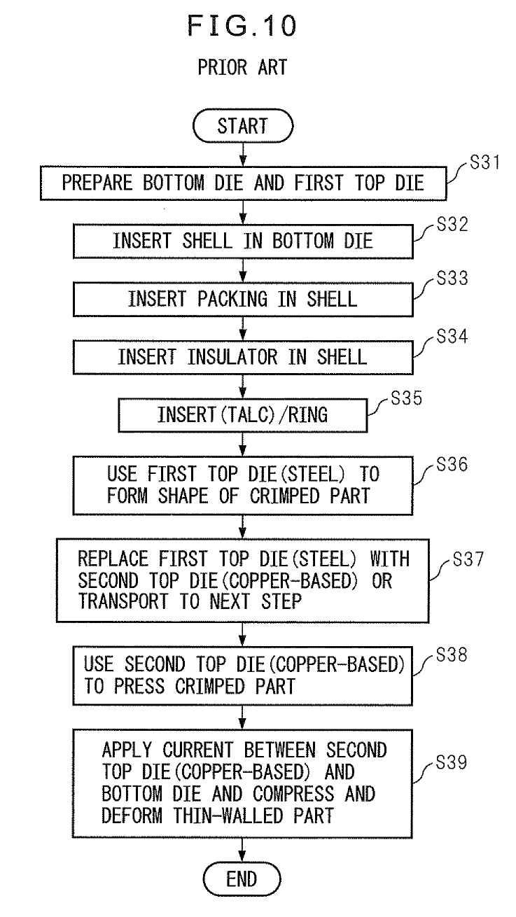

The horizontal electrodes 4 and the bottom die 2 are connected to a power supply 7 which together with the electrode drive units 6 constitutes a current supplying means. As shown in FIG. 18, by pressing the horizontal electrodes 4 against the six side surfaces of the hexagonal part 12c for close contact and, in that state, applying predetermined current from the power supply 7, it is possible to heat the hot crimped part 12b of the shell 12 at the current path by resistance heating. For this reason, the horizontal electrodes 4 and the bottom die 2 are made from a conductive material, for example, copper or a copper alloy. Further, as shown in FIG. 10, when performing the hot crimping, preferably the spark plug 1 is held between the wrap crimping top die 3 and the bottom die 2 and hot crimping is performed while pressing from the axial direction and radial direction.

As shown in FIG. 10, the crimping system of the present invention can perform the wrap crimping step, comprising gripping the spark plug 1 between the wrap crimping top die 3 and the bottom die 2 and using the pressing mechanism 5 to press the wrap crimping top die 3, and the hot crimping step, comprising using six horizontal electrodes 4 to clamp the side surfaces of the hexagonal part 12c and using the power supply 7 to apply current between the electrodes 4 and the bottom die, simultaneously or consecutively by a single system without switching parts. Next, one example of the procedure which is performed at the series of crimping steps will be explained in detail using the flowchart of FIG. 3.

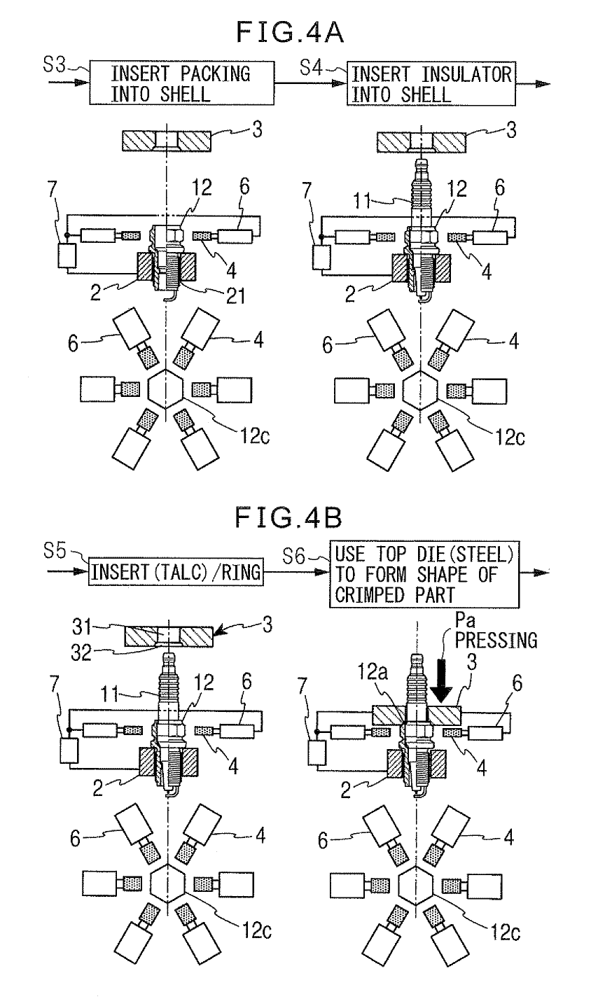

In the flowchart of FIG. 3 the crimping step is started, then, first, at step 1, the wrap crimping top die 3 and the bottom die 2 are prepared and are made to face each other across a predetermined distance in the axial direction. In this state, the wrap crimping top die 3 is above the shell 12, while the horizontal electrodes 4 are at their original positions separated from the sides of the shell 12 (see FIG. 1A). At the next step 2 and step 3, as shown in FIG. 4A, the shell 12 of the spark plug 1 is held at the bottom die 2, the packing 16 is inserted into the shell 12, then, at step 4, the insulator 11 is inserted into the shell 12.

Next, at step 5, as shown in FIG. 4B, the seal members are inserted inside of the top end opening of the shell 12. That is, in the case of the spark plug 1 of the structure which is shown in FIG. 2A, the ring 17 is inserted, while in the case of the spark plug 1 of the structure which is shown in FIG. 2B, the ring 19, talc 18, and ring 17 are successively inserted.

Step 6 is a wrap crimping step. The pressing mechanism 5 is used to move the wrap crimping top die 3 downward to press the top end opening of the thin-walled tube of the shell 12. At this time, the through hole 31 of the wrap crimping top die 3 is placed over the insulator 11. The top end opening part of the shell 12 plastically deforms to the inside along the round shape of the bottom end opening part 32 of the through hole 31 forming the shaping surface to thereby form the round shape wrap crimped part 12a. The pressing force Pa which is given by the pressing mechanism 5 is suitably set so that a necessary amount of deformation is obtained in accordance with the material of the shell 12 and the thickness etc. of the top end opening part of the wrap crimped part 12a.

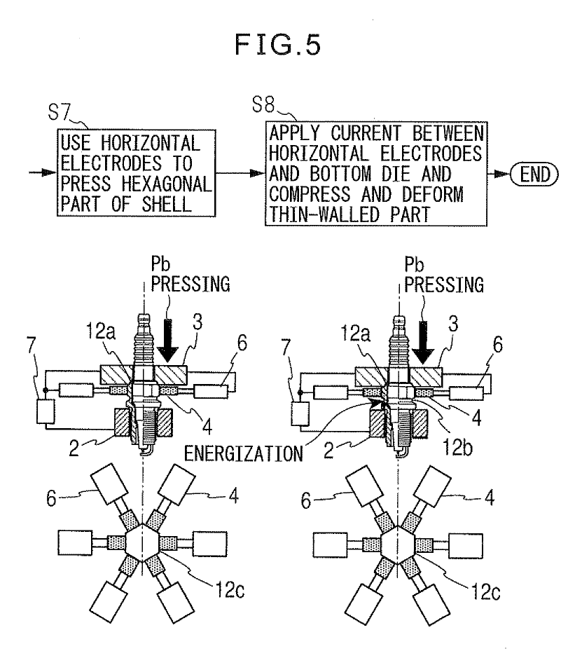

Steps 7 and 8 are hot crimping steps. As shown in FIG. 5, first, at step 7, the pressing force given by the pressing mechanism 5 is changed, the electrode drive units 6 are used to make the six horizontal electrodes 4 advance, and the six side surfaces of the hexagonal part 12c are pressed against. Due to this, in the state holding the spark plug 1 between the wrap crimping top die 3 and bottom die 2, the six horizontal electrodes 4 can be used to evenly press against the six side surfaces of the hexagonal part 12c. The pressing force Pb which is required for hot crimping need only be one which enables the heat generating part to be compressed and deformed by a predetermined amount in the axial direction. For example, it is possible to suitably set this in a range of not more than the pressing force Pa for the wrap crimping (Pb≦Pa). Further, the pressing force by the horizontal electrodes 4 may be a relatively small pressing force if able to make the front end faces of the horizontal electrodes 4 closely contact the side surfaces of the hexagonal part 12c and hold the part during the hot crimping. It may be suitably set so as to enable good conduction with the bottom die 2.

Next, at step 8, a predetermined current is applied between the horizontal electrodes 4 and bottom die 2 to heat the thin-walled part between the hexagonal part 12c and the flange part 14 by resistance heating. At this time, the thin-walled part softens due to the heat and is deformed by compression by the pressing force Pb in the axial direction. Furthermore, the thin-walled part which expanded due to the heat shrinks when returning to ordinary temperature whereby it is fastened to the outer circumference of the insulator 11 and the crimping force can be raised. The current which is applied between the horizontal electrodes 4 and the bottom die 2 is suitably set in accordance with the material etc. of the shell 12 so that the temperature at which the thin-walled part softens within a predetermined time.

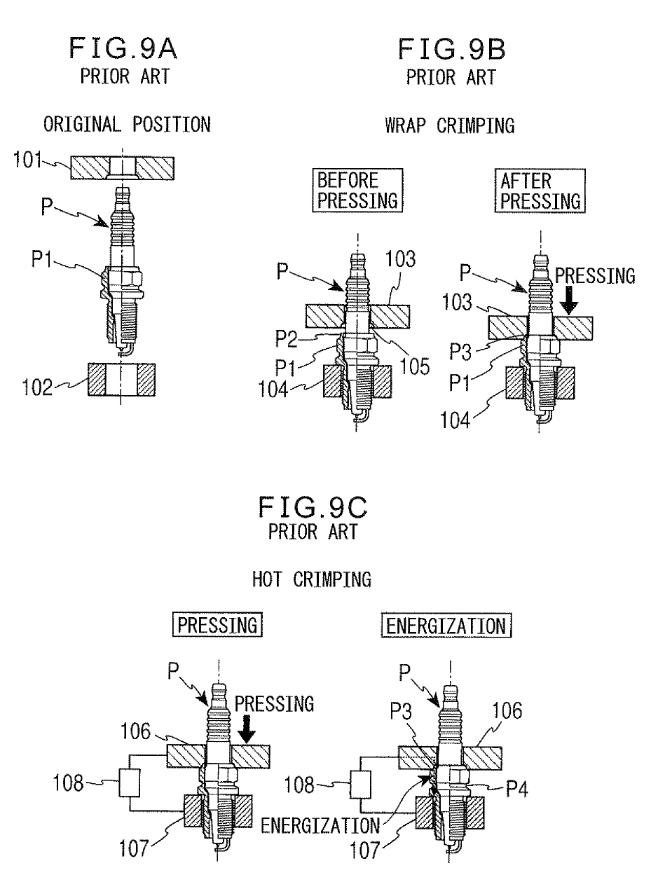

On the other hand, in the conventional crimping method which is shown in FIG. 9, as shown by the flowchart in FIG. 10, the crimping step is started, then, at step 31, the wrap crimping-use top die 103 (first top die) and bottom die 104 are prepared, then, at step 32 and step 33, the shell P1 of the spark plug P is held at the bottom die 104 and the packing is inserted. At step 34 and step 35, the insulator is inserted into the shell P1 and the ring and talc are inserted inside the top end opening part as seal members, while at the next step 36, the wrap crimping is performed. The steps up to here are similarly performed.

That is, at step 36, a not shown pressing mechanism is used to move the wrap crimping top die 103 (first top die) downward and the predetermined pressing force is used to press this to form the shape of the wrap crimped part. However, the wrap crimping top die 103 (first top die) is made of a steel-based material and cannot be used as a current-carrying electrode, so to perform the hot crimping, at step 37, it is necessary to switch the wrap crimping top die 103 (first top die) to the hot crimping top die 106 (second top die). Alternatively, the workpiece is transported to the next step. Further, it is set at a crimping system dedicated to hot crimping shown in FIG. 9C, then, step 38, the shell P1 held between the hot crimping top die 106 (second top die) and bottom die 107 made from a copper-based material is pressed by a predetermined pressing force. Furthermore, at step 39, the power supply 108 is used to apply current between the hot crimping top die 106 (second top die) and bottom die 107 and compress and deform the thin-walled part to form the hot crimped part.

In this way, according to the crimping method of the present invention, the shell of the workpiece, for example, the hexagonal part 12c of the shell 12 of the spark plug 1, is used to arrange horizontal electrodes 4 for hot crimping use at its sides, so a single crimping system using a common bottom die 2 and wrap crimping top die 3 can be made. Therefore, it is possible to form the hot crimping-use horizontal electrodes 4 and bottom die 2 by a copper-based conductive material to improve the conductivity and to form the wrap crimping top die 3 by a steel-based hard material to improve the wear resistance. Furthermore, the wrap crimping top die 3 and bottom die 2 can be utilized to performing the pressing required for the hot crimping. More than the necessary load is not applied to the horizontal electrodes 4 for hot crimping use, so the durability can be improved.

Further, after the warp crimping using the wrap crimping top die 3 and bottom die 2, hot crimping can be successively performed, so compared with the conventional method where the dies had to be switched or two crimping systems were required, it is possible to greatly shorten the time required for the processing. Further, the capital costs can be greatly reduced, so the productivity can be greatly improved.

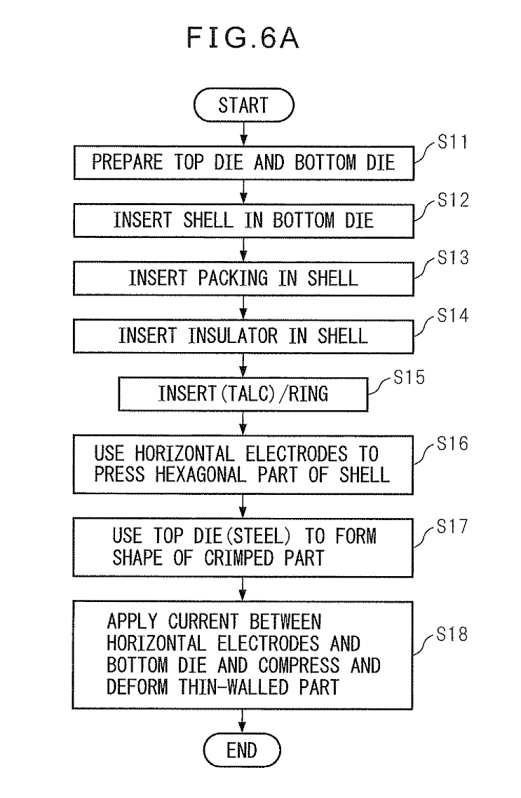

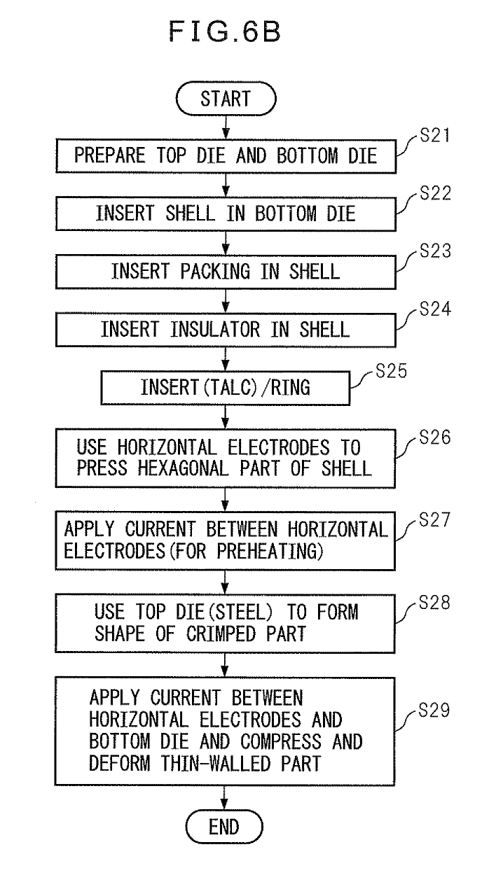

FIG. 6A shows a second embodiment of the present invention, while FIG. 68 shows a third embodiment of the present invention. The step of using the crimping system which is shown in FIG. 1 to form the wrap crimped part 12a and hot crimped part 12b at the shell 12 of the spark plug 1 is not limited to the procedure of steps 1 to 8 of the first embodiment which is shown in FIG. 3. Therefore, FIG. 6A shows an example of changing part of the order of the procedure, while FIG. 6B shows an example of adding other procedures.

In the second embodiment which is shown in FIG. 6A, steps 11 to 15 are similar to the first embodiment. After the crimping step is started, first, at step 11, the wrap crimping top die 3 and bottom die 2 are prepared, then, at step 12 and step 13, the shell 12 of the spark plug 1 is held at the bottom die 2 and packing 16 is inserted into the shell 12. After that, at steps 14 and 15, the insulator 11 is inserted into the shell 12 and the seal member of the ring 17 (talc 18 and ring 19) is inserted.

In the present embodiment, at step 16, before the wrap crimping step, the horizontal electrodes 4 for hot crimping use are made to advance using the electrode drive units 6 to press against the six side surfaces of the hexagonal part 12c. Due to this, the six horizontal electrodes 4 are used to evenly press and hold the six side surfaces of the hexagonal part 12c. In that state, at the next step 17, the wrap crimping is performed. At step 17, the pressing mechanism 5 is used to move the wrap crimping top die 3 downward and press the shell 12 of the spark plug 1 positioned between the wrap crimping top die 3 and bottom die 2. Due to this, the top end opening of the shell 12 plastically deforms to the inside along the round shape of the bottom end opening part 32 of the through hole 31 to form the round shape wrap crimped part 12a.

After that, at the hot crimping step of step 18, the pressing force by the pressing mechanism 5 is changed and a predetermined current is applied between the horizontal electrodes 4 for hot crimping use and the bottom die 2. Due to this, the thin-walled part between the hexagonal part 12c and the flange part 14 is compressed and deformed by the heat due to the running current and the pressing force to form the hot crimped part 12b.

The crimping system of the present invention is provided with a mechanism for wrap crimping use and a mechanism for hot crimping use in an independently movable manner, so the wrap crimping step and the hot crimping step can be simultaneously advanced. Therefore, like in the present embodiment, part of the hot crimping step can be performed before the wrap crimping step or the order can be changed.

Specifically, the step of using the pressing mechanism 5 to move the wrap crimping top die 3 downward and the step of using the electrode drive units 6 to push the horizontal electrodes 4 for hot crimping use to the six side surfaces of the hexagonal part 12c can be performed independently. Therefore, the timing at which the wrap crimping top die 3 abuts against the shell 12 and the timing at which the horizontal electrodes 4 abut against the hexagonal part 12c may be simultaneous or either may be first. The pressing mechanism 5 and electrode drive units 6 are controlled to give the desired timings. However, the step of changing the pressing force for hot crimping use (pressing force Pb) is performed after the step of using the pressing force by the wrap crimping top die 3 to form the wrap crimped part 12a (pressing force Pa). The order of these is not changed. Further, before or after any of these steps or simultaneously with them, a step of pressing the horizontal electrodes 4 against the hexagonal part 12c is performed, then suitably thereafter, a step of using the power supply 7 to conduct current with the bottom die is performed to form a hot crimped part 12b.

The third embodiment which is shown in FIG. 6B is a method using the second embodiment as its basic procedure. Steps 21 to 26 are similar to the second embodiment. First, the crimping step is started, then, at step 21, the wrap crimping top die 3 and bottom die 2 are prepared, then, at step 22 and step 23, the shell 12 of the spark plug 1 is held at the bottom die 2 and the packing 16 is inserted into the shell 12. After that, at steps 24 and 25, the insulator 11 is inserted into the shell 12 and the seal members of the ring 17 (talc 18 and ring 19) are inserted.

At step 26, before the wrap crimping step, the horizontal electrodes 4 for hot crimping use are made to advance using the electrode drive units 6 to press against the six side surfaces of the hexagonal part 12c. Due to this, the six horizontal electrodes 4 cause the six side surfaces of the hexagonal part 12c to be evenly pressed. In this state, furthermore, at step 27, current is applied between the horizontal electrodes 4 and the bottom die 2 to perform preheating. Here, usually, the prevent the preheating from causing the temperature of the shell 12 to rise more than necessary, the preheating-use current Ia may be suitably set in the range of the current Ib for hot crimping use or less (Ia≦Ib).

Next, at step 27, the pressing mechanism 5 is used to move the wrap crimping top die 3 downward and press the shell 12 of the spark plug 1 positioned between the wrap crimping top die 3 and the bottom die 2. Due to this, the top end opening of the shell 12 plastically deforms inside along the round shape of the bottom end opening part 32 of the through hole 31, whereby a round shaped wrap crimped part 12a is formed.

Furthermore, at step 28, the pressing force by the pressing mechanism 5 is changed and a current Ib for hot crimping is applied between the horizontal electrodes 4 for hot crimping use and the bottom die 2. This being so, the heat generated by the current and the pressing force are used to compress and deform the thin-walled part between the hexagonal part 12c and the flange part 14 and form the hot crimped part 12b. Further, at step 27, preheating is performed, so the shell 12 quickly rises in temperature and reaches a predetermined temperature, so the time which is required for hot crimping is shortened.

In this way, when performing the procedure for bringing the horizontal electrodes 4 for hot crimping use into close contact with the shell 12 before wrap crimping, it is also possible to easily perform the procedure of starting preheating before hot crimping. Note that, at step 16 and step 26 of FIG. 6A and FIG. 6B, it is also possible to drive the horizontal electrodes 4 and move the wrap crimping top die 3 downward to the abutting position of the shell 12 in advance. Further, these procedures may be used to further shorten the processing time and improve the productivity. In this case, in the above order of steps, after the step of pressing the horizontal electrodes 4 against the hexagonal part 12c, a step of supplying current for preheating and then suitably thereafter a step of supplying current for hot crimping is performed. Other procedures may be suitably selected.

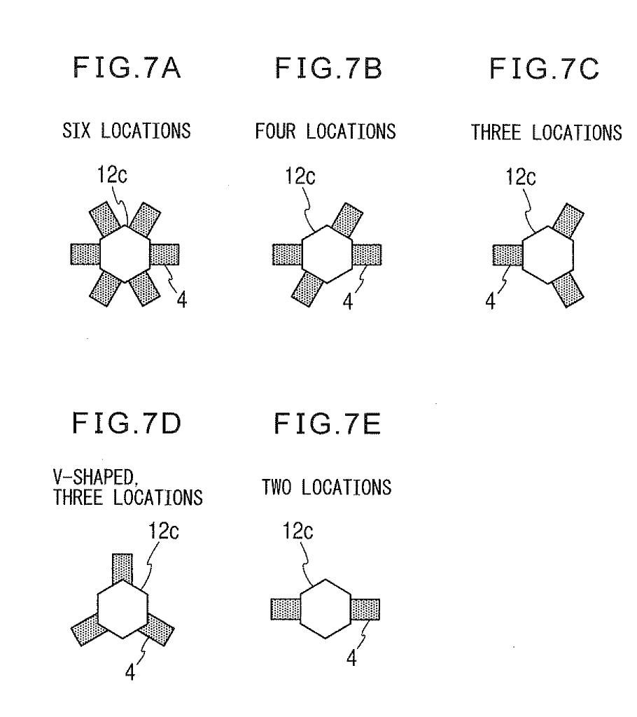

FIG. 7A to FIG. 7E show examples of the layout of the horizontal electrodes 4 for hot crimping use. In the above embodiments, as shown in FIG. 7A, horizontal electrodes 4 which have rectangular cross-sectional shapes are used and six such horizontal electrodes 4 are provided facing six locations, that is, all side surfaces, of the hexagonal part 12c of the shell 12 so as to make the flat front end faces closely contact the facing side surfaces, but the number of horizontal electrodes 4 may also be reduced if necessary. In this case, preferably the horizontal electrodes 4 are evenly arranged with respect to the six side surfaces of the hexagonal part 12c, for example, at two to four locations. For example, in the example of FIG. 7B, four horizontal electrodes 4 are arranged at all except two facing side surfaces, that is, at four side surfaces, of the hexagonal part 12c, while in the example of FIG. 7C, three horizontal electrodes 4 are arranged at every other of the six side surfaces of the hexagonal part 12c. As shown in the example of FIG. 7E, when using two horizontal electrodes 4, they are arranged at two facing side surfaces of the hexagonal part 12c to support the hexagonal part 12c from the two sides.

The planar shapes of the front ends of the horizontal electrodes 4 are not limited to rectangles. As shown in the example of FIG. 70, they may also be shapes fitting over the six angular corner parts of the hexagonal part 12c. At this time, in the example of FIG. 7D, three horizontal electrodes 4 with front end faces recessed to V-shapes corresponding to the corner parts are used and arranged in close contact at every other of the six corners of the hexagonal part 12c. It is also possible to arrange them at two or four of the six corner parts of the hexagonal part 12c or all of the corner parts (six locations) of the hexagonal part 12c.

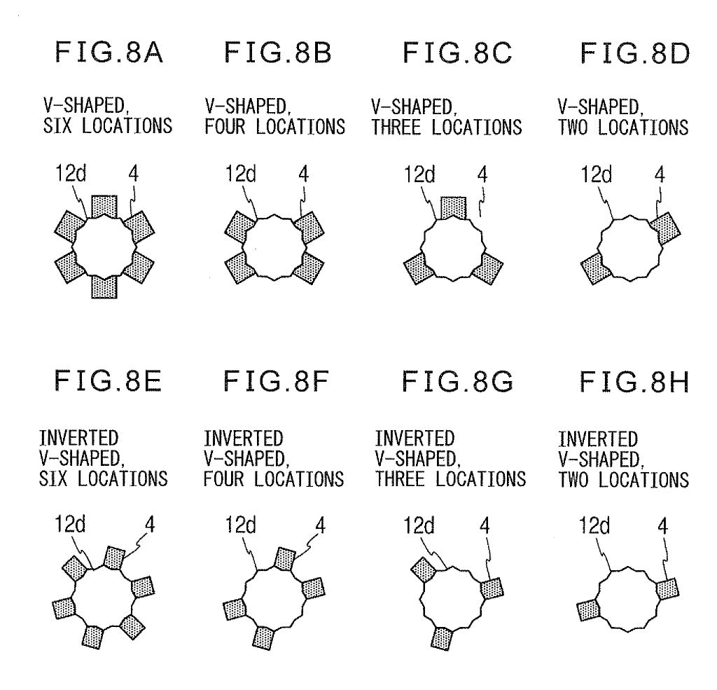

Furthermore, as shown in FIG. 8A to FIG. 8H, the thick-walled part of the shell 12 against which the horizontal electrodes 4 for hot crimping use abut is not limited to a hexagonal part 12c and may be any other polygonal or other outer shape. FIG. 8A shows an example of a thick-walled part 12d of a star-shaped cross-sectional shape which has a large number of V-shaped projections (here, 12 locations) at the outer circumference. In this case, the front end faces of the horizontal electrodes 4 are formed with V-shaped recesses which correspond to the V-shaped projections. Further, horizontal electrodes 4 are arranged in close contact at six locations at every other location among the 12 locations of the V-shaped projections of the thick-walled part 12d. Alternatively, as shown in FIG. 8B and FIG. 80, it is also possible to not set any two of the six horizontal electrodes 4 of FIG. 8A facing each other or to set only pairs facing each other. As shown in FIG. 8C, three horizontal electrodes 4 may also be evenly arranged.

Further, as shown in FIG. 8E to FIG. 8H, the front end faces of the horizontal electrodes 4 may also made shapes sticking out in V-shapes (reverse V-shapes). In this case as well, as shown in FIG. 8E, horizontal electrodes 4 are arranged in close contact at six locations at every other location among the 12 locations of the V-shaped recesses between the V-shaped projections of the thick-walled part 12d. Alternatively, as shown in FIG. 8F and FIG. 8H, it is also possible to not set any two of the six horizontal electrodes 4 of FIG. 8E facing each other or to set only pairs facing each other or, as shown in FIG. 8G, to evenly arrange three horizontal electrodes 4 may also be evenly arranged. Furthermore, the side surfaces of the shell 12 which the horizontal electrodes 4 for hot crimping use abut against are not limited to a thick-walled part like the hexagonal part 12c. It is sufficient that they be side surfaces through which current can be run with the flange part 14 across the thin-walled part for forming the hot crimped part 12b.

In this embodiment, a spark plug 1 is used to explain a crimping method and crimping system for crimping and fastening a shell 12 to the outer circumference of an insulator 11, but the invention is not limited to a spark plug 1. The present invention may be suitably utilized for any product which has a similar crimping structure. For example, a gas sensor which is used in an exhaust system of an internal combustion engine etc. is provided with a sensor body which holds a sensor device and with a tubular shell for attachment use at the outer circumference of the same. At the top end of the shell, there is a wrap crimped part, while at the bottom across a thick-walled part, there is a hot crimped part. Further, a seal member is filled inside the wrap crimped part, the sensor is screwed into a mounting hole of a cylinder head etc., and an air-tight seal is formed by the flange part below the hot crimped part and the gasket.

Therefore, the wrap crimped part and hot crimped part of such a sensor may be easily formed by a method similar to the above embodiments using the crimping system of FIG. 1. Further, the spark plug 1 and the sensor are not limited to the illustrated structures. The shapes of the different parts etc. may be freely changed.

In this way, the crimping method and crimping system of the present invention may be applied to any product of a structure where a wrap crimped part and a hot crimped part are used to crimp and fasten a shell to a main body. By performing the crimping simultaneously by a single step, there is the effect of greatly improving the productivity.

While the invention has been described by reference to specific embodiments chosen for purposes of illustration, it should be apparent that numerous modifications could be made thereto by those skilled in the art without departing from the basic concept and scope of the invention.

1. A crimping method comprising steps of:
holding at a first die a workpiece comprised of a main body around an outer circumference of which a tubular shell is placed;
moving a second die for wrap crimping use arranged facing the first die across said workpiece towards said first die so as to press the rim of one end of said shell, plastically deform the rim to an inner circumference side to thereby form a wrap crimped part; and
bringing hot crimping-use electrodes into contact with side surfaces of said shell to apply current between the electrodes and said first die and make a thin-walled part provided at current path of said shell generate heat by resistance heating to thereby form a hot crimped part.

2. A crimping method comprising steps of:
holding at a first die a workpiece comprised of a main body around an outer circumference of which a tubular shell is placed;
placing a second die for wrap crimping use facing the first die across said workpiece and moving said second die for wrap crimping use towards said first die so as to press the rim of one end of said shell and plastically deform the rim to an inner circumference side to thereby form a wrap crimped part; and
bringing hot crimping-use electrodes into contact with side surfaces of said shell, in the state holding said workpiece between said first die and said second die for wrap crimping use, to apply current between the electrodes and said first die and make a thin-walled part provided at current path of said shell generate heat by resistance heating to thereby form a hot crimped part.

3. A crimping method comprising steps of:
holding at a first die a workpiece comprised of a main body around an outer circumference of which a tubular shell is placed;
placing a second die for wrap crimping use at a position facing said first die across said workpiece and placing hot crimping-use electrodes at sides of said shell;
bringing said hot crimping-use electrodes placed at the sides of said shell into contact with side surfaces of said shell;
moving said second die for wrap crimping use towards said first die so as to press the rim of one end of said shell and plastically deform the rim to an inner circumference side to thereby form a wrap crimped part; and
in the state holding said workpiece between said first die and said second die for wrap crimping use, applying current between the hot crimping-use electrodes and said first die and make a thin-walled part provided at current path of said shell generate heat by resistance heating to thereby form a hot crimped part.

4. A crimping method comprising steps of:
holding at a first die a workpiece comprised of a main body around an outer circumference of which a tubular shell is placed;
placing a second die for wrap crimping use at a position facing said first die across said workpiece and placing hot crimping-use electrodes at sides of said shell;
bringing said hot crimping-use electrodes into contact with side surfaces of said shell, moving said second die for wrap crimping use towards said first die so as to abut against the rim of one end of said shell, and using said second die for wrap crimping use to press against the rim of the one end of said shell and plastically deform the rim to an inner circumference side to thereby form a wrap crimped part; and
in the state holding said workpiece between said first die and said second die for wrap crimping use, applying current between said hot crimping-use electrodes and said first die to make a thin-walled part provided at current path of said shell generate heat by resistance heating to thereby form a hot crimped part.

5. A crimping method comprising steps of:
holding at a first die a workpiece comprised of a main body around an outer circumference of which a tubular shell is placed;
placing a second die for wrap crimping use at a position facing said first die across said workpiece and placing hot crimping-use electrodes at sides of said shell;
bringing said hot crimping-use electrodes into contact with side surfaces of said shell and applying preheating-use current Ia between said hot crimping-use electrodes and said first die to preheat a thin-walled part provided in current path of said shell;
moving said second die for wrap crimping use towards said first die so as to press the rim of one end of said shell and plastically deform the rim to an inner circumference side to thereby form a wrap crimped part; and
in the state holding said workpiece between said first die and said second die for wrap crimping use, applying current between said hot crimping-use electrodes and said first die to make a thin-walled part provided at current path of said shell generate heat by resistance heating to thereby form a hot crimped part.

6. A crimping method as set forth in claim 1, wherein said wrap crimped part is formed by using said second die for wrap crimping use to press said workpiece by a pressing force Pa for wrap crimping use, while said hot crimped part is formed by running current through said hot crimping-use electrodes in the state using said second die for wrap crimping use to press said workpiece by a pressing force Pb for hot crimping use.

7. A crimping system comprising:
a first die for holding a workpiece comprised of a main body around an outer circumference of which a tubular shell is placed;
a second die for wrap crimping use which is arranged facing the first die across said workpiece;
hot crimping-use electrodes arranged at sides of said shell;
pressing means for moving said second die for wrap crimping use towards said first die and pressing one end of said shell by a predetermined pressing force; and
current supplying means for bringing said hot crimping-use electrodes into contact with side surfaces of said shell and applying predetermined current between the electrodes and said first die.

8. A crimping system as set forth in claim 7, wherein a plurality of said hot crimping-use electrodes are substantially equally arranged at the outer circumference of said shell.
